(19) United States
(12) Patent Application Publication
(10) Pub. No.: US 2010/0060115 A1
(43) Pub. Date: Mar. 11, 2010

(54) HOUSING AND METHOD MAKING THE SAME

(75) Inventors: GANG HUANG, Shenzhen City (CN); YAN-MIN WANG, Shenzhen City (CN); QIANG WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/549,161

(22) Filed: Aug. 27, 2009

(30) Foreign Application Priority Data
Sep. 10, 2008 (CN) 200810304450.4

(51) Int. Cl. A47B 81/00; B32B 37/10

(52) U.S. Cl. 312/223.1; 264/510

(57) ABSTRACT

A housing for use in a portable electronic device, comprises a base and a decorative film. The decorative film isintegrally molded with the base. The decorative film includes a surface facing away from the base. The decorative film is plastically deformed to form a plurality of spaced protrusions on the surface.

### BACKGROUND

1. Technical Field

The exemplary disclosure generally relates to housings and methods making the housings, and particularly to housings manufactured by In-Mold Labeling.

2. Description of Related Art

The external appearance of the housing of portable electronic device has become a key factor for attracting consumers.

The external appearance of the housing can usually be made by in-mold labeling (IML). A film with predetermined patterns, text, or pictures is placed in the die and directly molded to a housing molded within the die. Because the die walls and the film typically used in In-Mold labeling are smooth, the final labeled housing will have flat, monotonous surfaces. Therefore, the surfaces of the resulting labeled housing by IML may not exhibit an attractive appearance.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the exemplary housing and method making the housing. Moreover, in the drawings like reference numerals designate corresponding parts throughout the several views. Wherever possible, the same reference numbers are used throughout the drawings to refer to the same or like elements of an embodiment.

FIG. 1 is a schematic of a housing in accordance with an exemplary embodiment.

FIG. 2 is a partially enlarged view of the housing shown in FIG. 1.

FIG. 3 is a schematic view of a film for making the housing shown in FIG. 1.

FIG. 4 is a schematic view of a mold for making the housing shown in FIG. 1, showing one aspect.

FIG. 5 is a partially enlarged of a first mold of the mold shown in FIG. 4.

FIG. 6 is a schematic view of the mold in FIG. 4, but showing another aspect.

FIG. 7 is a schematic view when the film in FIG. 3 disposed within the first mold in FIG. 4.

FIG. 8 is a schematic view of the mold shown in FIG. 4 during molding.

FIG. 9 is a cross section view of the mold shown in FIG. 8.

### DETAILED DESCRIPTION

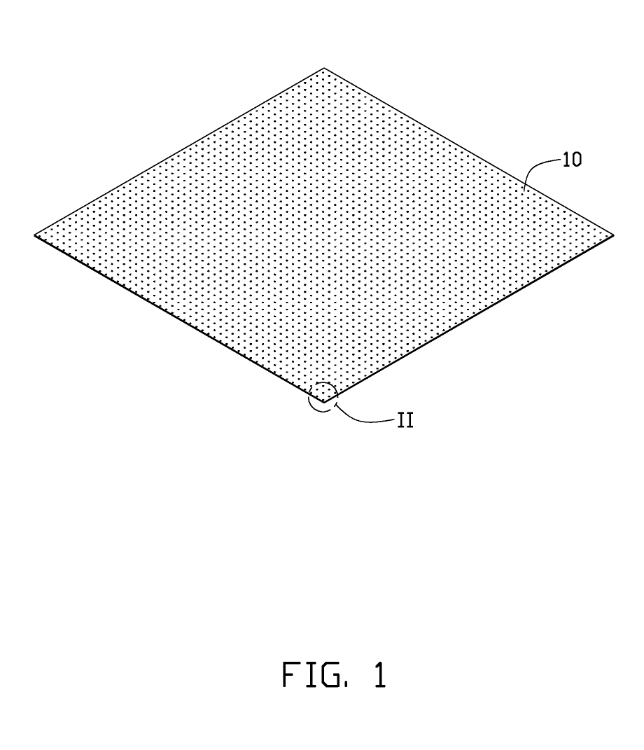

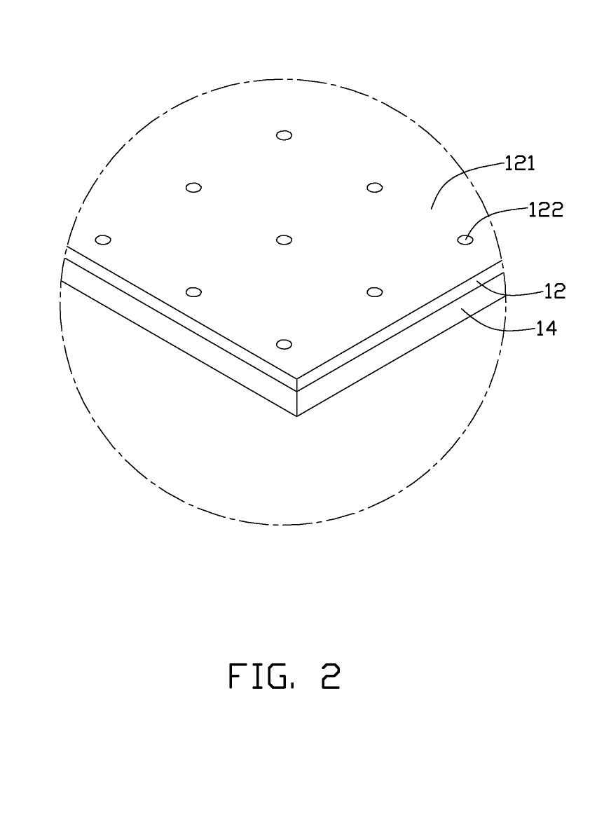

Referring to FIGS. 1 and 2, a portion of an exemplary embodiment of a molded housing 10 may be used with a portable electronic device (not shown), such as a cellular phone or any electronic device is shown. The molded housing 10 includes a base 14 integrally formed with a decorative film 12.

The base 14 may be made of a thermoplastic material chosen from the group consisting of polycarbonate, polymethyl methacrylate, polystyrene, and any combination thereof. The base 14 may also be made of silica gel.

The decorative film 12 may be made of e.g., polycarbonate (PC), or other thermoplastic materials including polymethyl methacrylate and polystyrene. The decorative film 12 includes a surface 121 facing away from the base 14. The decorative film 12 may be plastically deformed to form a plurality of protrusions 122 spaced at predetermined intervals with each other on the surface 121. The protrusions 122 may be spherical, or other may take other shapes, so that incident light on the surface 121 will be reflectively diffused.

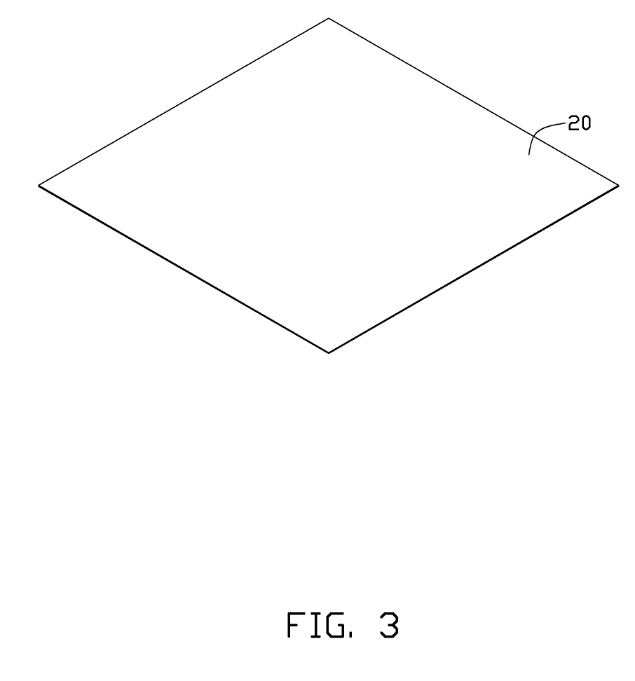

A method of making the molded housing 10 will now be described. Referring to FIG. 3, a film 20 is provided. The film 20 may be a polycarbonate thin film.

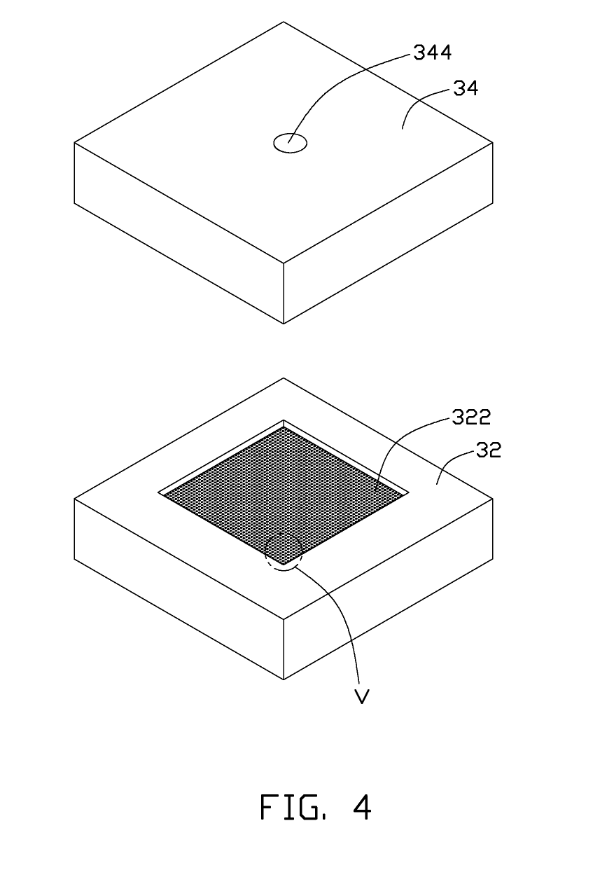

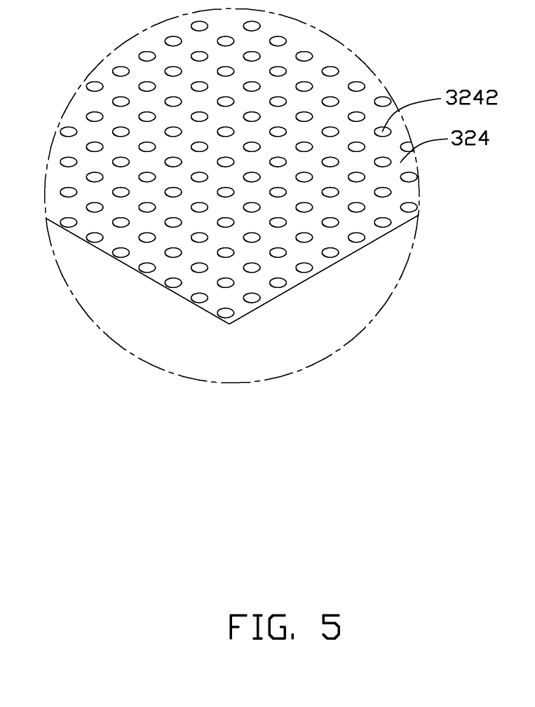

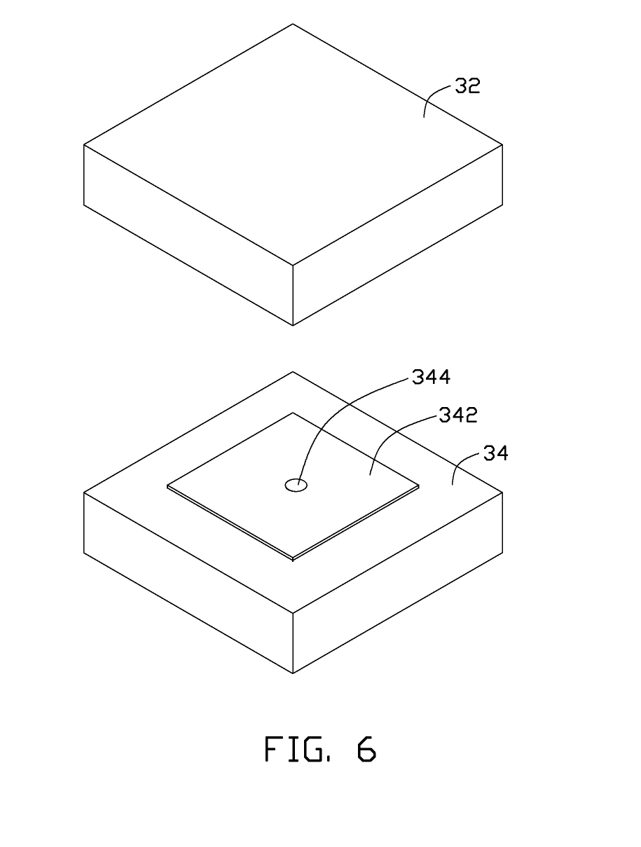

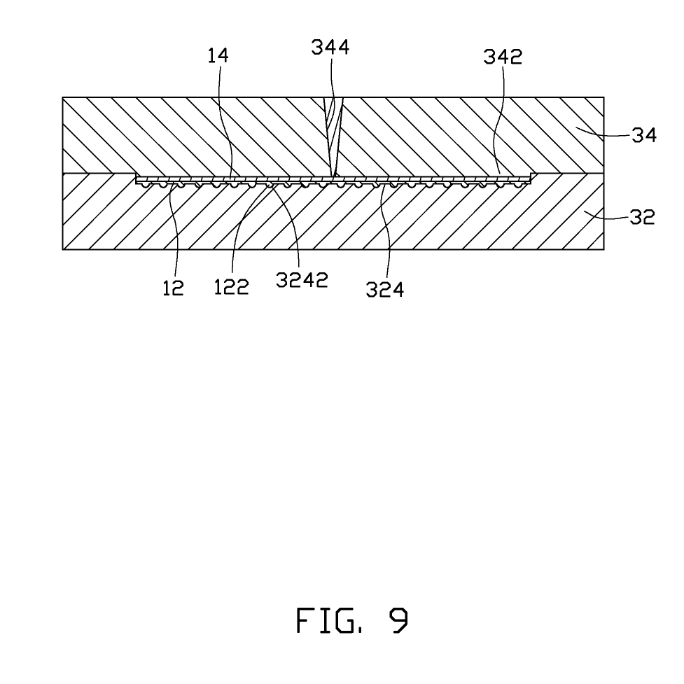

FIGS. 4 to 6 show a mold 30. The mold 30 includes a first mold 32 and a second mold 34 for engaging with the first mold 32. The first mold 32 defines a recessed portion 322 and a molding wall 324 at the bottom of the recessed portion 322. The molding wall 324 defines a plurality concave portions 3242 at predetermined distances from each other corresponding to the predetermined protrusions 122. The second mold 34 has a mold core 342 corresponding to the recessed portion 322. The second mold 34 defines a channel 344 (shown in FIG. 9) penetrating through the mold core 342.

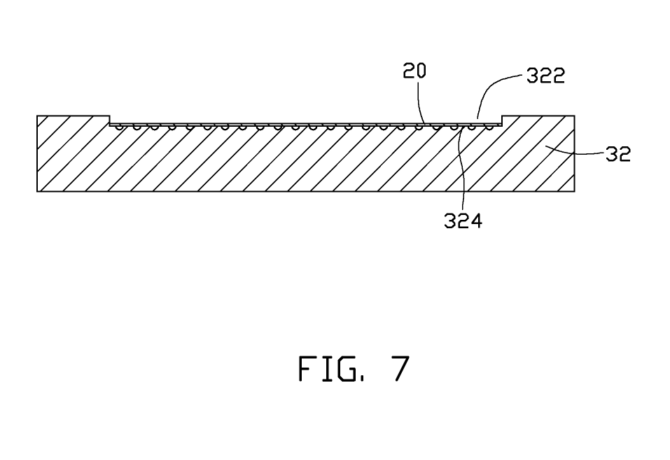

Referring to FIG. 7, the film 20 is securely positioned to the molding wall 324 in the recessed portion 322 of the first mold 32.

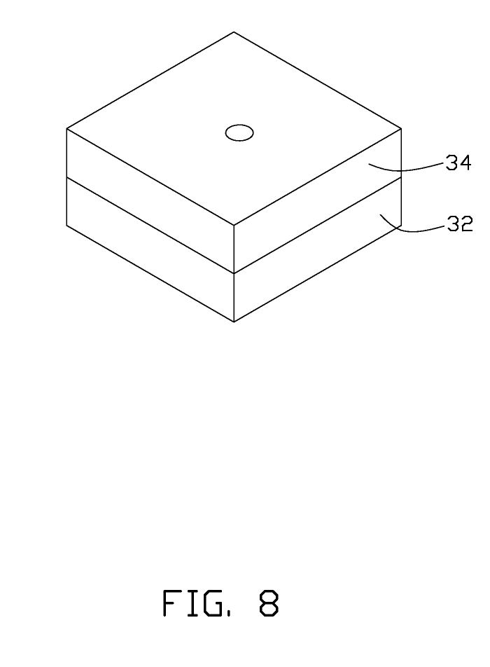

Referring to FIGS. 8 and 9, a molding cavity 36 is defined between the recessed portion 322 and the mold core 342. Molten plastic or silica gel is injected into the molding cavity 36 through the channel 344, to form the base 14. During this stage, the injected materials generate a pressure to securely attach the film 20 to the molding wall 324. The film 20 is heated and then softened by the molten plastic, thereby plastically deforming to yield the protrusions 122 on the film 20. Thus, the film 20 is converted/molded to the decorative film 12. As such, the housing 20 is formed in the mold 30. The molten plastic may be transparent plastic material chosen from the group consisting of polycarbonate, polymethyl methacrylate, polystyrene, and any desired combination thereof.

It is to be understood, however, that even though numerous characteristics and advantages of the exemplary disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing for use in a portable electronic device, comprising:
a base; and
a decorative film integrally molded with the base, the decorative film including a surface facing away from the base, and the decorative film plastically deformed to form a plurality of spaced protrusions on the surface.

2. The housing as claimed in claim 1, wherein each protrusion is hemispherical.

3. The housing as claimed in claim 1, wherein the decorative film is made of thermoplastic material.

4. The housing as claimed in claim 3, wherein the thermoplastic material is chosen from the group consisting of polycarbonate, polymethyl methacrylate, polystyrene.

5. The housing as claimed in claim 1, wherein the base is made of thermoplastic material.

6. The housing as claimed in claim 5, wherein the thermoplastic material is chosen from the group consisting of polycarbonate, polymethyl methacrylate, polystyrene.

7. A method for making a housing, comprising:
providing a film;
providing a mold including an first mold and a second mold, the first mold defining a recessed portion and a molding wall formed in the recessed portion, the molding wall having a plurality of spaced concave portions formed thereon, the second mold having a mold core;
attaching the film to the molding wall and in the recessed portion;
closing the mold, a molding cavity being defined between the recessed portion and the mold core;
injecting molten plastic into the molding cavity to form a base, and the base attached to the film;
wherein the molten plastic generates a pressure to tightly attach the film on the molding wall; and
heating and plastically deforming the film to form a plurality of spaced protrusions corresponding to the concave portions.

8. The housing as claimed in claim 7, wherein each concave portion is hemisphere.

9. The method as claimed in claim 7, wherein the decorative film is made of thermoplastic material.

10. The method as claimed in claim 8, wherein the thermoplastic material is chosen from the group of polycarbonate, polymethyl methacrylate, polystyrene.

11. The method as claimed in claim 7, wherein the base is made of thermoplastic material.

12. The method as claimed in claim 11, wherein the thermoplastic material is chosen from the group of polycarbonate, polymethyl methacrylate, polystyrene.
